(19) United States
(12) Patent Application Publication
(10) Pub. No.: US 2015/0348177 A1
(43) Pub. Date: Dec. 3, 2015

(54) MANAGING LEASE TRANSACTIONS IN DISTRIBUTED SYSTEMS

(71) Applicant: International Business Machines Corporation, Armonk, NY (US)

(72) Inventors: David J. Craft, Wimberly, TX (US); Shevaun-Ann M. Fontenot, Georgetown, TX (US); Eric P. Fried, Austin, TX (US); Lance W. Russell, Rosanky, TX (US)

(73) Assignee: International Business Machines Corporation, Armonk, NY (US)

(21) Appl. No.: 14/289,704

(22) Filed: May 29, 2014

(51) Int. Cl. G06Q 30/06; H04L 12/26; H04L 29/08

(52) U.S. Cl. CPC G06Q 30/0645; H04L 67/22; H04L 43/0852

(57) ABSTRACT

A computer-implemented method of managing lease transactions from a plurality of time-synchronized cluster nodes for a shared leased resource in a computer network, the method including accepting, during a request period, requests to lease a shared leased resource in an upcoming lease interval, the requests received from among a plurality of time-synchronized cluster nodes. The method may include selecting, during a response period which concludes prior to the beginning of the upcoming lease interval, a leaseholder for the shared leased resource in the upcoming lease interval in response to receiving at least one request during the request period, the leaseholder selected based on the at least one received request. The response period may occur after the request period. The method may include notifying, during the response period, the selected leaseholder of its selection as the leaseholder for the shared leased resource in the upcoming lease interval.

### BACKGROUND

The present disclosure relates to a computer implemented method of managing lease transactions from a plurality of time-synchronized cluster nodes. Quorum servers may use the concept of leases to authorize cluster nodes to operate with shared resources in a computer network. As a lease expires, network latency and other factors may cause inoperative periods for the shared resource when one cluster node's lease expires and needs to be replaced by another. Reducing or eliminating the inoperative period may increase the total working time of the shared leased resource in the computer system.

### SUMMARY

According to embodiments of the present disclosure, a computer-implemented method of managing lease transactions from a plurality of time-synchronized cluster nodes for a shared leased resource in a computer network, the method including accepting, during a request period, requests to lease a shared leased resource in an upcoming lease interval, the requests received from among a plurality of time-synchronized cluster nodes.

The method may include selecting, during a response period which concludes prior to the beginning of the upcoming lease interval, a leaseholder for the shared leased resource in the upcoming lease interval in response to receiving at least one request during the request period, the leaseholder selected based on the at least one received request. The response period may occur after the request period. The method may include notifying, during the response period, the selected leaseholder of its selection as the leaseholder for the shared leased resource in the upcoming lease interval.

The method may further include notifying, during the response period, the plurality of time-synchronized cluster nodes of the selected leaseholder for the shared leased resource in the upcoming lease interval. The method may further include rejecting requests to lease the shared leased resource in the upcoming lease interval received outside of the request period. The request period and the response period may occur during a first lease interval for the shared leased resource and the upcoming lease interval may occur immediately after the first lease interval.

The first lease interval may have a first leaseholder. Selecting the leaseholder during the response period may include selecting, in response to receiving a request from the first leaseholder during the request period, that the first leaseholder is the leaseholder for the shared leased resource in the upcoming lease interval. The method may further include accepting, during the response period, requests to lease the shared leased resource in the upcoming lease interval in response to not receiving requests during the request period. The method may further include selecting the request first received during the response period.

Selecting the leaseholder may be based on a network latency parameter of the plurality of time-synchronized cluster nodes. The duration of the request period and the response period may be based on a network latency parameter of the plurality of time-synchronized cluster nodes. The plurality of time-synchronized cluster nodes may be time-synchronized using network time protocol.

A distributed computer system for managing lease transactions from a plurality of time-synchronized cluster nodes for a shared leased resource in a computer network may include a plurality of time synchronized cluster nodes, a shared leased resource, and a quorum server. The quorum server may be configured to accept, during a request period, requests to lease the shared leased resource in an upcoming lease interval, the requests received among a plurality of time-synchronized cluster nodes. The quorum server may be configured to select, during a response period which concludes prior to the beginning of the upcoming lease interval, a leaseholder for the shared leased resource in the upcoming lease interval in response to receiving at least one request during the request period, the leaseholder selected based on the at least one received request, the response period occurring after the request period. The quorum server may be configured to notify, during the response period, the selected leaseholder of its selection as the leaseholder for the shared leased resource in the upcoming lease interval. The quorum server may be further configured to reject requests to lease the shared leased resource in the upcoming lease interval received outside of the request period.

The quorum server may be further configured to accept, during the response period, requests to lease the shared leased resource in the upcoming lease interval in response to not receiving requests during the request period. The quorum server may be further configured to select the request first received during the response period.

A computer program product for managing lease transactions from a plurality of time-synchronized cluster nodes for a shared leased resource in a computer network, the computer program product may include a computer readable storage medium having program instructions embodied therewith. The program instructions executable by a computer may cause the computer to perform a method including accepting, during a request period, requests to lease a shared leased resource in an upcoming lease interval, the requests received among a plurality of time-synchronized cluster nodes. The method may include selecting, during a response period which concludes prior to the beginning of the upcoming lease interval, a leaseholder for the shared leased resource in the upcoming lease interval in response to receiving at least one request during the request period, the leaseholder selected based on the at least one received request, the response period occurring after the request period. The method may include notifying, during the response period, the selected leaseholder of its selection as the leaseholder for the shared leased resource in the upcoming lease interval.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4A depicts a distributed network on which embodiments of the present disclosure may be implemented.

FIG. 4B depicts a distributed network using a storage area network on which embodiments of the present disclosure may be implemented.

FIG. 5 depicts a timeline of lease intervals including request periods and response periods according to embodiments of the present disclosure.

FIG. 6 depicts a flow chart diagram of a method of managing lease transactions according to embodiments of the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate to resource leases of shared network resources, more particular aspects relate to management of lease transactions from time-synchronized cluster nodes. While the present disclosure is not necessarily limited to such applications, various aspects of the disclosure may be appreciated through a discussion of various examples using this context.

While the same nomenclature and same numbers may be used to identify elements throughout the disclosure, this practice is not intended to limit the scope of the disclosure. Identified elements in one figure may not be identical to other same named or identified elements in other figures.

Distributed systems may use the concept of leases to allocate temporary control of computing resources (“resources”) to multiple computing components, such as computing nodes or clusters of computing nodes (“cluster nodes”) in the distributed system. The cluster nodes may communicate and coordinate actions across a shared network. As a part of this communication and coordination, resources in the network may be shared between the cluster nodes so that the cluster nodes can perform one or more processes. In order for the computing resources to be properly shared across the distributed system, access by the computing nodes may be controlled in order to reduce instances of simultaneous access of resources, which may lead to errors, data corruption, crashes, and other problems.

Leases may be used in a distributed system to control access to resources by a plurality of cluster nodes. Leases may grant exclusive access to one or more shared computing resources for a specific duration of time (“lease interval”). Cluster nodes may issue lease requests to a control server, such as a quorum server, in the distributed system for leaseholder status. The quorum server may then select a cluster node among the requesting cluster nodes as the leaseholder for a particular lease interval. Because leaseholder status may grant exclusive access over resources, and because the control server may have time boundaries for when lease request may be accepted, coordination between the cluster nodes may be useful for an efficient lease-based system.

In embodiments, processes running on the cluster nodes may share a particular storage volume provided by a disk array to interface (read and write data) to the particular storage volume. In order to share the storage volume, a particular cluster node may require exclusive access to the particular storage volume at one time, as data may not be able to be written or read from the same particular storage volume simultaneously. In certain embodiments, processes running on the cluster nodes may share one or more processors having a load threshold. Leases may be used to control cluster node access to the processors so that the processes requested by the cluster node do not push the processor load over the load threshold.

Because each cluster node in a distributed system may be physically located apart from other cluster nodes and connected via a network, such as in a cloud based distributed system, network latency for communications between the cluster nodes may hinder coordination between the nodes. For example, network latency may result in time de-synchronization between the cluster nodes, where one or more of the cluster nodes do not agree on when leases expire, or when lease requests should be submitted to the control server.

Further, lease-based implementations may suffer from inoperative periods where no cluster node has access. This may be due to network latency, or delay due to the time it takes the system to select the next leaseholder from among the requesting cluster nodes. These inoperative periods may typically occur between when a first lease interval ends and when a second lease interval begins. Inoperative periods may result in a shared leased resource in the system which is underutilized or unutilized in some instances. By reducing the inoperative period, more efficient use of shared leased resources in the distributed system may be obtained.

A method of managing lease transactions from a plurality of time-synchronized cluster nodes may include accepting, during a request period, requests to lease a shared leased resource in an upcoming lease interval. The requests may be received from a plurality of time-synchronized cluster nodes. The method may include selecting, during a response period which concludes prior to the beginning of the upcoming lease interval, a leaseholder for the shared leased resource in the upcoming lease interval. The leaseholder may be selected in response to receiving at least one request during the request period. The leaseholder may be selected based on the at least one received request. The method may include notifying, during the response period, the selected leaseholder of its selection as the leaseholder for the shared leased resource in the upcoming lease interval.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

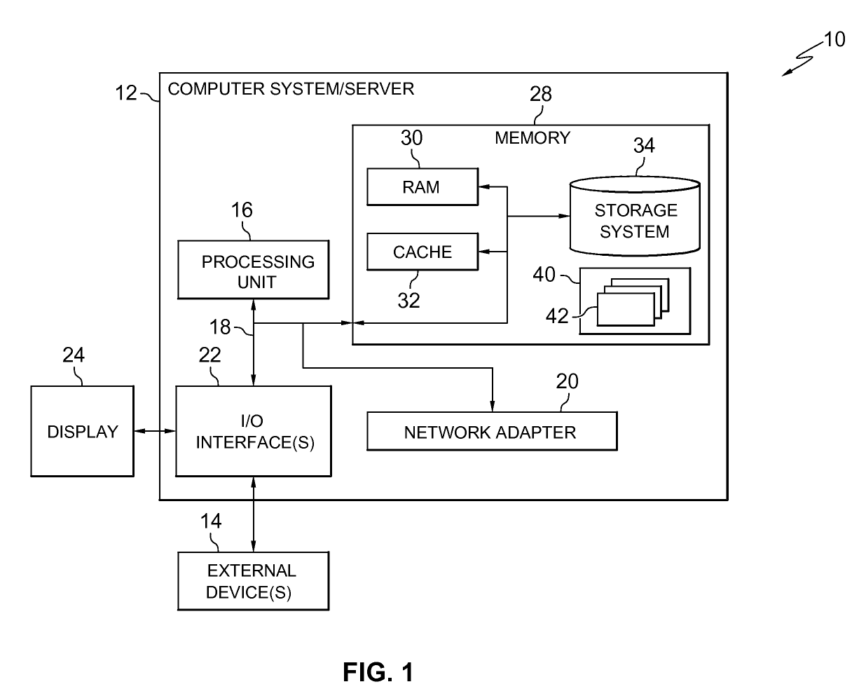

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

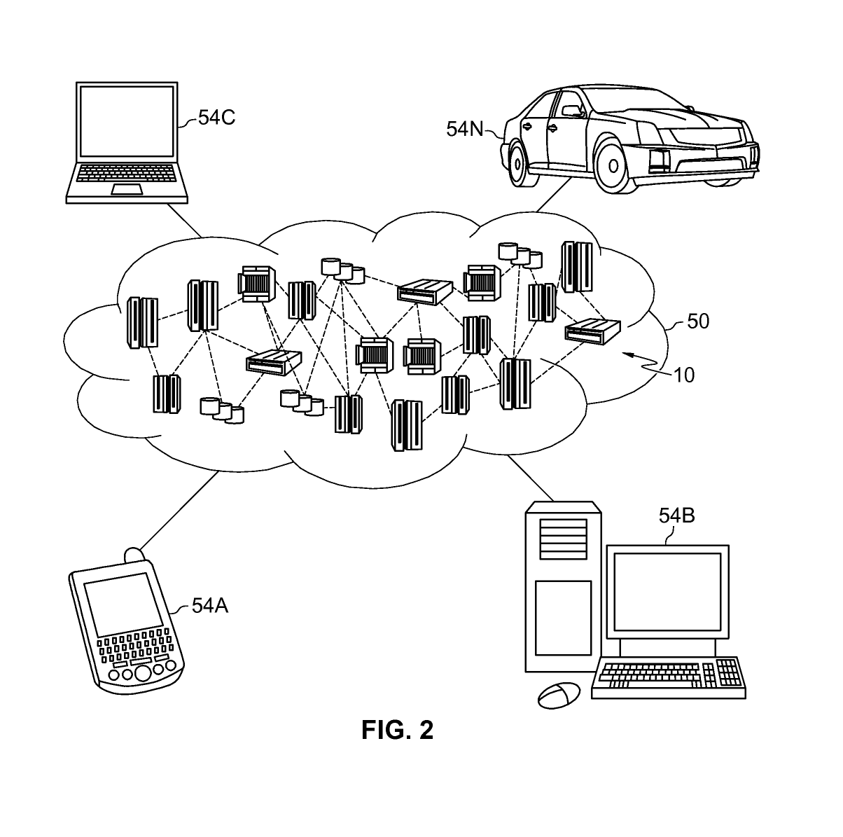

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

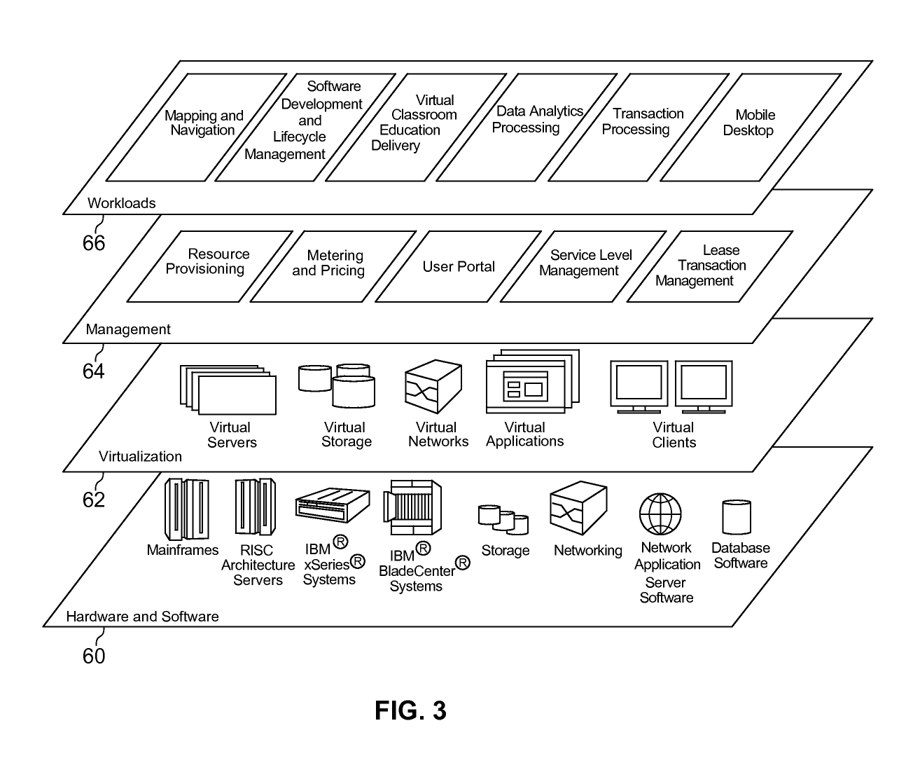

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. Lease transaction management may manage lease requests from cluster nodes for a shared leased resource in a distributed system.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

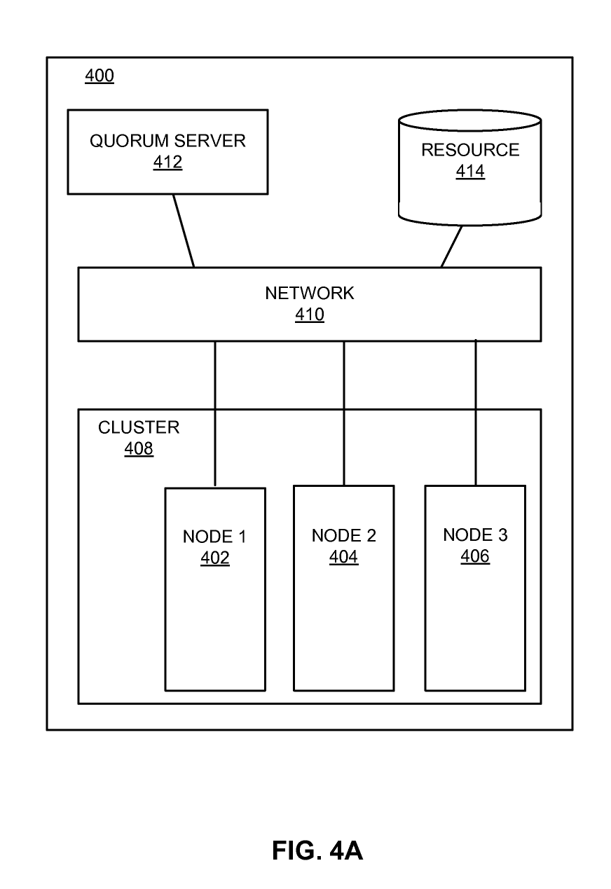

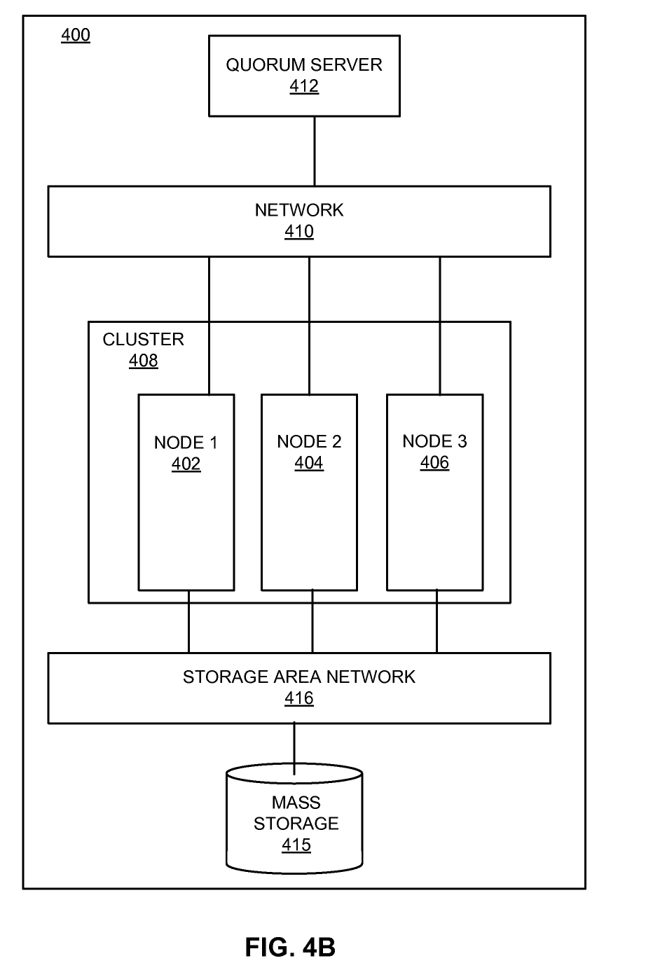

Referring now to FIG. 4A a distributed system 400 may be seen according to embodiments of the present disclosure. The distributed system 400 may include a plurality of cluster nodes 402, 404, 406 arranged as a first cluster 408. The plurality of cluster nodes 402, 404, 406 may be communicatively connected to one or more networks 410 with a quorum server 412 and a shared leased resource 414.

The plurality of cluster nodes 402, 404, 406, may each be computer systems capable of executing applications and computing processes. In embodiments, each of the plurality of cluster nodes 402, 404, 406 may be a computer system, such as computer system including one or more individual computer processors, and may support concurrent or simultaneous execution of high volumes of processes. The plurality of cluster nodes 402, 404, 406 may be arranged in a first cluster 408. The cluster nodes 402, 404, 406 may be communicatively connected to each other through a dedicated network, such as a local area network, or a cloud based network. The plurality of cluster nodes 402, 404, 406 may be communicatively connected in order to operate with each of the other cluster nodes 402, 404, 406 and to achieve improved performance relative to similar un-clustered computer nodes.

The first cluster 408 may be a virtual server, which represents the cluster nodes 402, 404, 406 operating together in the distributed system 400. Each cluster may be a physical server. Taken together, these cluster nodes may make up the virtual server in the distributed system 400.

For example, as explained herein, the cluster nodes 402, 404, 406 may submit requests to the quorum server 412 to be exclusive leaseholder over a shared leased resource in the distributed system. The leaseholder status is temporary however, and expires once a lease interval period ends. In order to coordinate requests for leaseholder status, the cluster nodes 402, 404, 406 may be time-synchronized so that the cluster nodes can determine when lease intervals end and when to submit lease requests to the quorum server 412. In embodiments, the cluster nodes 402, 404, 406 are time-synchronized in the first cluster 408 using Networking Time Protocol (NTP). In certain embodiments, the cluster nodes 402, 404, 406 may be time-synchronized using precision time protocol, or other suitable network protocols.

In embodiments, the first cluster 408 may be a server cluster. In a server cluster, physical servers in the virtual server may run applications which cannot be distributed across all of the physical servers. In embodiments, only one cluster node in the server cluster may be active at a time. The other cluster nodes may be placed in a stand-by mode where they wait to take over execution of an application if the active node should fail. The other cluster nodes may be able to assume control over an application when the active node fails because all of the cluster nodes in the first cluster 408 may be connected to a shared leased resource, such as a shared disk array, used to execute the application. In certain embodiments, the first cluster 408 may be a network load balancing cluster, where an application can run across all of the cluster nodes 402, 404, 406 simultaneously. In a network load balancing each cluster node 402, 404, 406 may run its own individual copy of the application.

The one or more networks 410 may communicatively connect the plurality of cluster nodes 402, 404, 406, the quorum server 412, and the shared resource 414 in the distributed system 400. In embodiments, data may be exchanged between the elements in the distributed network 400 through one or more networks 410. Many different types of computer networks may be used including wireless connections or wired connections such as fibre channel connections, Ethernet connections, or other suitable type of connection. The one or more networks 410 may be a local network such as a LAN, may be a wide area network, such as a cloud based network, or other type of network. The one or more networks 410 may utilize multiple types of protocols and configurations such as, TCP/IP, or other suitable network protocols.

The quorum server 412 may provide control functions over the first cluster 408. In embodiments where the first cluster 408 is a server cluster, the quorum server may serve as control over the cluster nodes 402, 404, 406, in order for the cluster nodes to perform processes while decreasing the chances of two or more cluster nodes interfering with execution of processes. In embodiments, the quorum server 412 may control the first cluster 408 when the first cluster is a server cluster. The quorum server 412 may control when each of the cluster nodes 402, 404, 406 are active and when each of the cluster nodes 402, 404, 406 are in stand-by mode. In embodiments, the quorum server 412 may control access to the shared leased resource 414. As described herein, the cluster nodes 402, 404, 406, may issue lease requests to the quorum server 412. The quorum server 412 may select a leaseholder among the requesting cluster nodes to be the leaseholder for a particular lease interval.

Processes running on distinct cluster nodes of the plurality of cluster nodes 402, 404, 406 may share access to the shared leased resource 414. In embodiments, the shared leased resource may be a mass storage device, such as a disk array. Processes running on the plurality of cluster nodes 402, 404, 406 may share a particular storage volume provided by the disk array to interface (read and write data) to the particular storage volume. In order to share the disk array, a particular cluster node 402, 404, 406 may require exclusive access to a particular storage volume at one time, as data may not be able to be written or read from the same particular storage volume simultaneously. Thus, a particular cluster node among the plurality of cluster nodes 402, 404, 406 may be granted exclusive access to the disk array in order for processes on the particular cluster node to interface with the shared particular storage volumes of the disk array without interference from other processes on other cluster nodes.

In embodiments, this mass storage device may be a RAID array, a storage area network, or other type of storage device. In embodiments, other types of resources may be shared within the distributed system 400. The shared leased resource may be shared among the plurality of cluster nodes 402, 404, 406 and may include one or more processors, memory, such as DRAM, input/output devices, communications devices, and other suitable devices both physical and logical.

Referring now to FIG. 4B a distributed system 400 may be seen according to embodiments of the present disclosure. The distributed system 400 may include a plurality of cluster nodes 402, 404, 406 grouped in a first cluster 408. The plurality of cluster nodes 402, 404, 406 may be communicatively connected together in a network 410 with a quorum server 412. The plurality of cluster nodes 402, 404, 406 may also be communicatively connected together in a storage area network 416 with a mass storage device 415.

The plurality of cluster nodes 402, 404, 406, may each be computer systems capable of executing applications and computing processes. The plurality of cluster nodes 402, 404, 406 may be the same or substantially similar as described herein. The first cluster 408 may be a virtual server, which represents the cluster nodes 402, 404, 406 operating together in the distributed system 400. The first cluster 408 may be the same or substantially similar as described herein. The one or more networks 410 may communicatively connect the plurality of cluster nodes 402, 404, 406 and the quorum server 412. The one or more networks 410 may be the same or substantially similar as described herein.

The quorum server 412 may provide control functions over the first cluster 408. The quorum server 412 may be the same or substantially similar as described herein.

The storage area network 416 may connect the plurality of cluster nodes 402, 404, 406, with the mass storage device 415 to give the plurality of cluster nodes 402, 404, 406 access to the mass storage device 415. The storage area network 416 may be a dedicated network that provides access to a storage medium, such as the mass storage device 415. The storage area network 416 may be constructed as a local area network, wide area network, such as a cloud based network, or other suitable type of network. The mass storage device 415 may a disk array. Processes running on the plurality of cluster nodes 402, 404, 406 may share a particular storage volume provided by the disk array to interface (read and write data) to the particular storage volume. In order to share the disk array, a particular cluster node 402, 404, 406 may require exclusive access to a particular storage volume at one time, as data may not be able to be written or read from the same particular storage volume simultaneously. Thus, a particular cluster node among the plurality of cluster nodes 402, 404, 406 may be granted exclusive access to the disk array in order for processes on the particular cluster node to interface with the shared particular storage volumes of the disk array without interference from other processes on other cluster nodes.

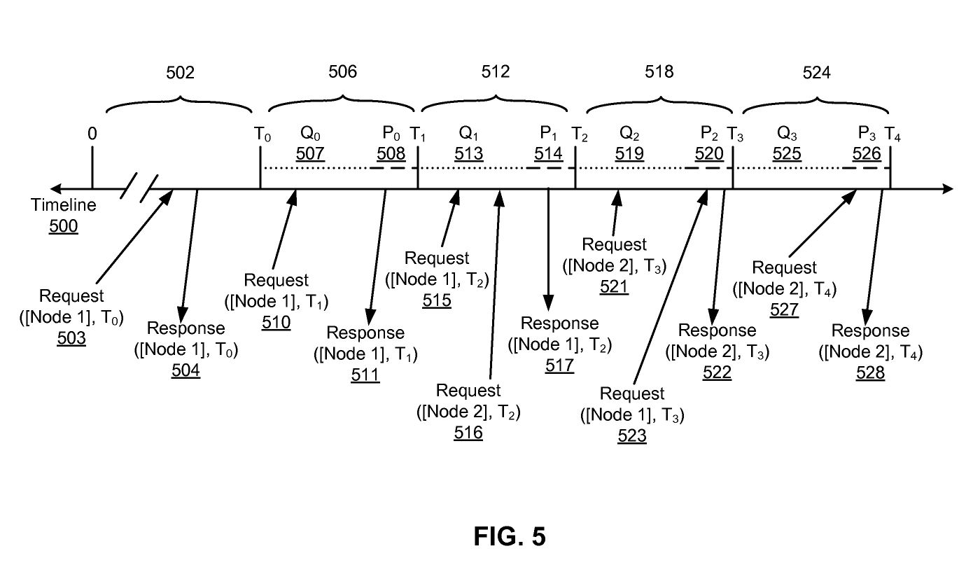

Referring now to FIG. 5 a timeline of leaseholders for a shared leased resource in a distributed system may be seen according to embodiments of the present disclosure. The timeline 500 may be split into one or more time intervals including an initial interval 502 and a plurality of lease intervals (T₀-T₄), 506, 512, 518, 524. The initial interval 502 represents a period where there is no active leaseholder for the shared leased resource. Periods T₀-T₄, 506, 512, 518, 524 represent periods where a time-synchronized cluster node has leaseholder status over the shared leased resource.

Each lease interval (T₀-T₄) 506, 512, 518, 524, may include both a request period (Q₀-Q₃) 507, 513, 519, 525 and a response period (P₀-P₃) 508, 514, 520, 526. In embodiments, the request period and the response period together may have a duration less than or equal to the duration of the lease interval such that Q+P≦T. The response periods 508, 514, 520, 526 and request periods 507, 513, 519, 525 may have varying durations in each lease interval 506, 512, 518, 524. For example, in embodiments, the response period 508, 514, 520, 526 and the request period 507, 513, 519, 525 may be based on current network latency conditions for a plurality of cluster nodes 402, 404, 406 (FIG. 4A, 4B). In embodiments, the response period 508, 514, 520, 526 and request period 507, 513, 519, 525 may be increased in duration as a network latency parameter increases. The network latency parameter may include but is not limited to, ping and packet loss. In certain embodiments, the response period 508, 514, 520, 526 and request period 507, 513, 519, 525 may be increased in duration but only to the extent that the response period and the request period together have a duration less than or equal to the duration of the lease interval.

Lease requests 503, 510, 515, 516, 521, 523, 527 may be accepted from the plurality of time-synchronized cluster nodes during periods Q₀-Q₃, 507, 513, 519, 525. Selection of which requesting cluster node should be the leaseholder may be made during periods P₀-P₃. Responses 504, 511, 517, 522, 528 may be issued from the control server during periods P0-P3, 508, 514, 520, 526.

Lease requests 503, 510, 515, 516, 521, 523, 527 may be issued to a control server, such as a quorum server 412 (FIG. 4A, 4B) from the plurality of time-synchronized cluster nodes. The lease request may be issued at various points on the timeline 500. The lease requests 503, 510, 515, 516, 521, 523, 527 are a request by a cluster node of the plurality of cluster nodes to be the leaseholder for the shared leased resource for a particular lease interval. The leaseholder may have exclusive access to the shared leased resource for the duration of the lease interval. In embodiments, the leaseholder's lease will only expire prior to the end of the lease interval if the current holder explicitly revokes it. The lease request may include the lease interval requested and identification of which cluster node is sending the request. While lease requests 503, 510, 515, 516, 521, 523, 527 may be issued from the cluster nodes at various points on the timeline 500, whether or not the lease request is received by the control server may be based on when the lease request was sent and other factors as described herein.

Responses may be issued from the control server during periods P0-P3, 508, 514, 520, 526. The control server may respond with the identity of the selected lease holder and the time at which that lease begins. In embodiments, the responses 504, 511, 517, 522, 528 may be delivered to all requestors for that particular lease interval. In certain embodiments, the responses 504, 511, 517, 522, 528 may only be issued to the cluster node selected as the leaseholder for the specified lease interval. In certain embodiments, the responses 504, 511, 517, 522, 528 may be issued to every cluster node in the distributed system. Thus, when the corresponding lease begins, the nodes which have been responded to may be already aware of the selected leaseholder and can begin to behave accordingly. Thus, the inoperative period may be reduced and more efficient use of shared leased resources in the distributed system may be obtained.

In FIG. 5, lease requests 503, 510, 515, 516, 521, 523, 527 are shown with the cluster node making the request and when the requested lease interval would begin. For example lease request 503 is shown as (Node 1, T₀) indicating the request is coming from cluster node 1 and the leaseholder status would begin at T₀, for lease interval 502. The responses 504, 511, 517, 522, 528 are shown with the cluster node selected as leaseholder and with when the lease holding status will begin. For example, response 504 is shown as (Node 1, T₀) indicating cluster node 1 has been selected as the leaseholder for lease interval 506.

As shown in FIG. 5 the timeline 500 may begin with an initial interval 502. During the initial interval 502, no cluster node has control over the shared leased resource. During this interval, a system implementing embodiments of the disclosure may wait until a lease request is received before selecting a first leaseholder. During initial interval 502 lease request 503 is received and response 504 is sent indicating that node 1 has been selected as the leaseholder for lease interval 506. In embodiments, when there is no active leaseholder the control server may select the first lease request received as the leaseholder.

In lease interval 506, the shared leased resource may be active and may be assigned exclusively to node 1 for the duration of 506. Lease interval 506 may contain a request period Q₀ 507, and a response period P₀ 508. In embodiments, at any time during an active lease interval for a shared leased resource, a cluster node may request an upcoming lease interval for the same shared leased resource. During the request periods Q₀-Q₃, lease requests for the upcoming interval may be accepted from a plurality of cluster nodes 402, 404, 406 (FIG. 4A, 4B), for access to the shared leased resource. Lease request 510 is received in Q₀, 507 from node 1 for access to the shared leased resource in lease interval T₁, 512. In embodiments, the plurality of cluster nodes may only request an upcoming lease interval which occurs immediately after the active lease interval. In certain embodiments, the plurality of cluster nodes may request any upcoming lease interval for the shared leased resource.

Response 511 is sent during P₀, 508 notifying the selected cluster node 1 that it has been selected as the leaseholder for lease interval 512. When a leaseholder is selected, access to the shared leased resource may not take effect until the current active lease interval has ended and the upcoming lease interval begins.

In lease interval 512, the shared leased resource may be active and may again be assigned exclusively to node 1 for the duration of 512. Lease interval 512 may contain a request period Q₁ 513, and a response period P₁ 514. Lease request 515 is received in Q₁, 513 from node 1 for access to the shared leased resource in lease interval 518. Lease request 516 is also received in Q₁, 513 from node 2 for access to the shared leased resource in lease interval 518. In embodiments, when multiple requests arrive during the request period the multiple requests may be treated as if they had arrived simultaneously during the request period.

Because at least two requests have been received from cluster servers for the same shared leased resource for the same lease interval, selection of a leaseholder among the requesting cluster nodes may be made during P₁, 514. The selection of which requesting cluster node will be the leaseholder may be based on multiple factors. For example, selection of the leaseholder may be made by various factors including making a priority determination of requesting nodes and selecting the node with the highest priority. Other factors may include selecting the first request to arrive when a network latency parameter, such as ping, packet loss, or other suitable network latency parameter, in the distributed system is greater than a threshold. Other factors may include picking nodes using a round robin selection protocol, or a protocol based on load balancing among the plurality of cluster nodes. Other suitable factors may be used however.

After the selection of the leaseholder has been made, response 517 is sent during P₁, 514 notifying the selected cluster node 1, prior to the expiration of period P1, 514 that it has been selected as the leaseholder for lease interval 518. Thus, as lease interval 518 begins, the leaseholder is already determined and any inoperative period between 512 and 518 is decreased.

In lease interval 518, the shared leased resource may be active and may again be assigned exclusively to node 1 for the duration of 518. Lease interval 518 may contain a request period Q₂ 519, and a response period P₂ 520. Lease request 521 is received in Q₂, 519 from node 2 for access to the shared leased resource in lease interval 524. Additionally, lease request 523 is received in P₂, 520 from node 1 for access to the shared leased resource in lease interval 524. In embodiments, if one or more viable requests come in during the request period, then any subsequent requests arriving during the response period may be immediately rejected. Thus, lease requests may only be considered during the request period. In embodiments, the nodes sending lease requests during the response period are issued the response notifying the node of the selected leaseholder for the upcoming lease interval. Thus, the node receiving responses for requests arriving during the response period may determine that it must reapply to be considered for the subsequent lease.

In lease interval 524, the shared leased resource may be active and is assigned exclusively to node 2 for the duration of 524. Lease interval 524 may contain a request period Q₃ 525, and a response period P₃ 526. As seen in FIG. 5, no lease requests arrive during the request period Q₃ 525. In embodiments, if no lease requests arrive during request period requests arriving during the response period for the corresponding request period are given first-come priority. Lease request 527 is received during response period P₃ 526. While lease request 527 arrives during period P₃ 526, no lease request was received during request period Q₃ 525. Thus, the lease request 527 from node 2 may be accepted and node 2 may be selected as the leaseholder for the upcoming lease interval.

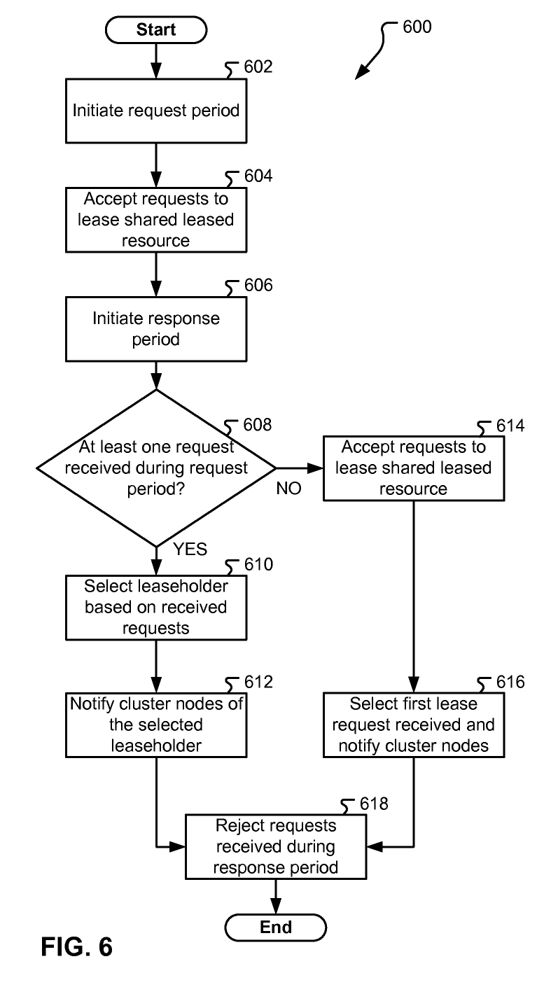

Referring now to FIG. 6 a flow diagram of a method 600 of managing lease transactions from a plurality of time-synchronized cluster nodes for a shared leased resource in a computer network may be seen according to embodiments of the present disclosure. In operation 602, a request period may be initiated. During the request period, a control server, such as a quorum server, may accept lease requests to be leaseholder of a shared leased resource. The lease requests may be issued from a plurality of cluster nodes. The request period may be the same or substantially similar as described herein.

In operation 604, requests to lease a shared leased resource may be accepted. The requests to lease may include identification of which cluster node is submitting the request and for what lease interval the cluster node is requesting leaseholder status. The shared leased resource and the lease requests may be the same or substantially similar as described herein.

In operation 606, a response period may be initiated. During the response period, selection of the leaseholder may be made from among the cluster nodes which issued lease requests. The response period may be the same or substantially similar as described herein.

If at least one request is received during the request period then, in decision block 608, the method may progress to operation 610. In operation 610, a leaseholder is selected based on the at least one received request. Selection of the leaseholder may be based on multiple factors as described herein and the method may progress to operation 612. In operation 612, one or more of the cluster nodes may be notified of the selected leaseholder. Notifying the cluster nodes of the selected leaseholder may be the same or substantially similar as described herein. The method may then progress to operation 618.

If no request is received during the request period then, in decision block 608, the method may progress to operation 614. In operation 614, requests to lease the shared leased resource arriving during the response period may be accepted. In operation 616, the first lease request submitted during the response period may be selected as the leaseholder and the cluster nodes may be notified of the selected leaseholder.

In operation 618, requests which are received during the response period may be rejected. The one or more of the plurality of cluster nodes which are rejected may be notified of the selected leaseholder. Notifying the plurality of cluster nodes of the selected leaseholder may be the same or substantially similar as described herein.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method of managing lease transactions from a plurality of time-synchronized cluster nodes for a shared leased resource in a computer network, the method comprising:
accepting, during a request period, requests to lease a shared leased resource in an upcoming lease interval, the requests received from among a plurality of time-synchronized cluster nodes;
selecting, during a response period which concludes prior to the beginning of the upcoming lease interval, a leaseholder for the shared leased resource in the upcoming lease interval in response to receiving at least one request during the request period, the leaseholder selected based on the at least one received request, the response period occurring after the request period; and
notifying, during the response period, the selected leaseholder of its selection as the leaseholder for the shared leased resource in the upcoming lease interval.

2. The method of claim 1, further comprising:
notifying, during the response period, the plurality of time-synchronized cluster nodes of the selected leaseholder for the shared leased resource in the upcoming lease interval.

3. The method of claim 1, further comprising:
rejecting requests to lease the shared leased resource in the upcoming lease interval received outside of the request period.

4. The method of claim 1, wherein the request period and the response period occur during a first lease interval for the shared leased resource and wherein the upcoming lease interval occurs immediately after the first lease interval.

5. The method of claim 4, wherein the first lease interval has a first leaseholder, and wherein selecting the leaseholder during the response period includes:
selecting, in response to receiving a request from the first leaseholder during the request period, that the first leaseholder is the leaseholder for the shared leased resource in the upcoming lease interval.

6. The method of claim 1, further comprising:
accepting, during the response period, requests to lease the shared leased resource in the upcoming lease interval in response to not receiving requests during the request period; and
selecting the request first received during the response period.

7. The method of claim 1, wherein selecting the leaseholder is based on a network latency parameter of the plurality of time-synchronized cluster nodes.

8. The method of claim 1, wherein the duration of the request period and the response period is based on a network latency parameter of the plurality of time-synchronized cluster nodes.

9. The method of claim 1, wherein the plurality of time-synchronized cluster nodes are time-synchronized using network time protocol.

10. A distributed computer system for managing lease transactions from a plurality of time-synchronized cluster nodes for a shared leased resource in a computer network, the system comprising:
a plurality of time synchronized cluster nodes;
a shared leased resource; and
a quorum server configured to:
accept, during a request period, requests to lease the shared leased resource in an upcoming lease interval, the requests received among a plurality of time-synchronized cluster nodes;
select, during a response period which concludes prior to the beginning of the upcoming lease interval, a leaseholder for the shared leased resource in the upcoming lease interval in response to receiving at least one request during the request period, the leaseholder selected based on the at least one received request, the response period occurring after the request period; and
notify, during the response period, the selected leaseholder of its selection as the leaseholder for the shared leased resource in the upcoming lease interval.

11. The system of claim 10, wherein the quorum server is further configured to:
reject requests to lease the shared leased resource in the upcoming lease interval received outside of the request period.

12. The system of claim 10, wherein the response period occurs after the request period and wherein the request period and the response period occur prior to the upcoming lease interval.

13. The system of claim 10, wherein the request period and the response period occur during a first lease interval for the shared leased resource and wherein the upcoming lease interval occurs immediately after the first lease interval.

14. The system of claim 13, wherein the first lease interval has a first leaseholder, and wherein selecting the leaseholder during the response period includes:
selecting in response to receiving a request from the first leaseholder during the request period, that the first leaseholder is the leaseholder for the shared leased resource in the upcoming lease interval.

15. The system of claim 10, wherein the quorum server is further configured to:
accept, during the response period, requests to lease the shared leased resource in the upcoming lease interval in response to not receiving requests during the request period; and
select the request first received during the response period.

16. The system of claim 10, wherein selecting the leaseholder is based on a network latency parameter of the plurality of time-synchronized cluster nodes.

17. The system of claim 10, wherein the duration of the request period and the response period is based on a network latency parameter of the plurality of time-synchronized cluster nodes.

18. The system of claim 10, wherein the plurality of time-synchronized cluster nodes are time-synchronized using network time protocol.

19. A computer program product for managing lease transactions from a plurality of time-synchronized cluster nodes for a shared leased resource in a computer network, the computer program product comprising a computer readable storage medium having program instructions embodied therewith, the program instructions executable by a computer to cause the computer to perform a method comprising:
accepting, during a request period, requests to lease a shared leased resource in an upcoming lease interval, the requests received among a plurality of time-synchronized cluster nodes;
selecting, during a response period which concludes prior to the beginning of the upcoming lease interval, a leaseholder for the shared leased resource in the upcoming lease interval in response to receiving at least one request during the request period, the leaseholder selected based on the at least one received request, the response period occurring after the request period; and
notifying, during the response period, the selected leaseholder of its selection as the leaseholder for the shared leased resource in the upcoming lease interval.

20. The computer program product of claim 1, wherein the method further comprises:
notifying, during the response period, the plurality of time-synchronized cluster nodes of the selected leaseholder for the shared leased resource in the upcoming lease interval.
